(19) United States
(12) Patent Application Publication
(10) Pub. No.: US 2025/0158462 A1
(43) Pub. Date: May 15, 2025

(54) ROTOR, ROTOR MANUFACTURING APPARATUS, AND ROTOR MANUFACTURING METHOD

(71) Applicant: NIDEC CORPORATION, Kyoto (JP)

(72) Inventors: Tadashi HOTORI, Kyoto (JP); Takeshi HONDA, Kyoto (JP); Hiroshi KITAGAKI, Kyoto (JP)

(21) Appl. No.: 18/840,491

(22) PCT Filed: Feb. 21, 2023
(86) PCT No.: PCT/JP2023/006315

§ 371 Date: Aug. 22, 2024

(30) Foreign Application Priority Data
Feb. 28, 2022 (JP) 2022-029847

(51) Int. Cl. H02K 1/278; H02K 5/04; H02K 15/028; H02K 15/121; H02K 15/142

(52) U.S. Cl. CPC H02K 1/278; H02K 5/04; H02K 15/028; H02K 15/121; H02K 15/142

(57) ABSTRACT

A rotor includes a columnar rotor core extending in the axial direction, a rotor cover covering a radially outer side of the rotor core, and a resin portion covering a one-side end surface in the axial direction of the rotor core. The rotor cover includes a protruding portion protruding to one side in the axial direction with respect to the one-side end surface in the axial direction of the rotor core. The resin portion includes, on the radially outer side, an edge portion that protrudes to one side in the axial direction and is in contact with the radially inner side of the protruding portion.

### CROSS-REFERENCE TO RELATED APPLICATIONS

This is the U.S. national stage of application No. PCT/JP2023/006315, filed on Feb. 21, 2023, and priority under 35 U.S.C. § 119(a) and 35 U.S.C. § 365(b) is claimed from Japanese Patent Application No. 2022-029847, filed on Feb. 28, 2022.

### FIELD OF THE INVENTION

The present invention relates to a rotor, a rotor manufacturing apparatus, and a rotor manufacturing method.

### BACKGROUND

In an inner rotor type DC brushless motor including a permanent magnet type rotor, a configuration including a scattering prevention cover is known in order to prevent scattering of a permanent magnet fixed to the rotor.

For example, conventionally, there is a motor rotor in which an annular rotor magnet arranged concentrically around a rotor shaft and a cover body that is made of nonmagnetic metal and covers an outer peripheral side of the rotor magnet are integrally molded with a molding resin.

Conventionally, there is a motor rotor in which an outer peripheral surface of an annular rotor magnet is covered with a cover body, and an inner diameter side and both axial ends of the rotor magnet are covered with a mold resin. Accordingly, scattering of the magnet can be prevented, and the motor rotor can be used even in liquid.

Incidentally, when a rotor cover that covers the radially outer side of the rotor core has a protruding portion protruding in the axial direction of the rotor core, vibration occurs in the protruding portion of the rotor cover when the rotor rotates. Therefore, in the rotor in which the rotor cover has the protruding portion, a configuration capable of suppressing vibration generated in the protruding portion during rotation of the rotor is required.

### SUMMARY

An exemplary rotor according to an embodiment of the present invention includes a columnar rotor core extending in an axial direction, a rotor cover covering a radially outer side of the rotor core, and a resin portion covering a one-side end surface of the rotor core in the axial direction. The rotor cover includes a protruding portion protruding to one side in the axial direction with respect to the one-side end surface in the axial direction of the rotor core. The resin portion includes, on the radially outer side, an edge portion that protrudes to one side in the axial direction and is in contact with the radially inner side of the protruding portion.

An exemplary rotor manufacturing apparatus according to an embodiment of the present invention is a manufacturing apparatus that manufactures a rotor in which a radially outer side of a columnar rotor core, extending in an axial direction, is covered with a rotor cover, and a one-side end surface of the rotor core in the axial direction is covered with a resin portion. The rotor manufacturing apparatus includes a first mold that holds the rotor cover that covers the radially outer side of the rotor core in a state where a protruding portion protrudes to one side the axial direction with respect to the one-side end surface in the axial direction of the rotor core; a second mold that is located on the one side in the axial direction of the first mold so as to be relatively movable in the axial direction with respect to the first mold and forms a space between the second mold and the one-side end surface in the axial direction of the rotor core; and a resin injection portion from which resin is injected into the space. The second mold includes a gap forming portion that forms a gap between the second mold and the protruding portion in the radial direction on a radially inward side of the protruding portion of the rotor cover in a state where the rotor core and the rotor cover are sandwiched between the second mold and the first mold.

An exemplary rotor manufacturing method according to an embodiment of the present invention is a method of manufacturing a rotor in which a radially outer side of a columnar rotor core, extending in an axial direction, is covered with a rotor cover, and a one-side end surface of the rotor core in the axial direction is covered with a resin portion. The rotor manufacturing method includes a rotor cover attaching step of inserting the rotor core into the rotor cover, the axial length of the rotor cover is larger than the axial length of the rotor core, and positioning a one-side end portion in the axial direction of the rotor cover at a position protruding to the one-side end surface in the axial direction of the rotor core; a mold disposition step of sandwiching the rotor core and the rotor cover between a first mold and a second mold to form a space between the second mold and the one-side end surface of the rotor core in the axial direction, and form a gap between the second mold and the one-side end portion of the rotor cover on an inward side of the one-side end portion of the rotor cover; and a resin injection step of injecting resin into the space and the gap.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a schematic configuration of a rotor according to an embodiment;

FIG. 2 is a cross-sectional view taken along line II-II in FIG. 1;

FIG. 3 is a cross-sectional view taken along line III-III in FIG. 1;

FIG. 4 is a perspective view of the rotor cover illustrated in FIG. 1 as viewed from a bottom side;

FIG. 5 is a diagram describing one step included in a method of manufacturing the rotor according to the embodiment;

FIG. 6 is a schematic view illustrating a state in which a workpiece in which a rotor core and a rotor magnet are inserted into a rotor cover is set in a mold of a rotor manufacturing apparatus; and

FIG. 7 is a schematic view for explaining a resin injection step in the rotor manufacturing method.

### DETAILED DESCRIPTION

Hereinafter, an exemplary embodiment of the present invention will be described in detail with reference to the drawings. The same or corresponding parts in the drawings are denoted by the same reference numerals, and the description thereof will not be repeated. In addition, the dimensions of the components in the drawings do not faithfully represent the actual dimensions of the components, the dimensional ratios of the components, and the like.

Hereinafter, in the description of a rotor 30 and a rotor core 31, a direction parallel to a central axis P of the rotor 30 and the rotor core 31 is referred to as an “axial direction”, “axial”, or “axially”, a direction orthogonal to the central axis P is referred to as a “radial direction”, “radial”, or “radially”, and a direction along an arc centered on the central axis P is referred to as a “circumferential direction”, “circumferential”, or “circumferentially”. However, this definition is not intended to limit the orientation of the rotor 30 and the rotor core 31 during use.

Further, in the following description, expressions such as “fixed”, “connected” and “attached” (hereinafter, fixed or the like) are used not only when the members are directly fixed to each other, but also when the members are fixed via another member. That is, in the following description, the expression such as fixing includes the meaning of direct and indirect fixing between members.

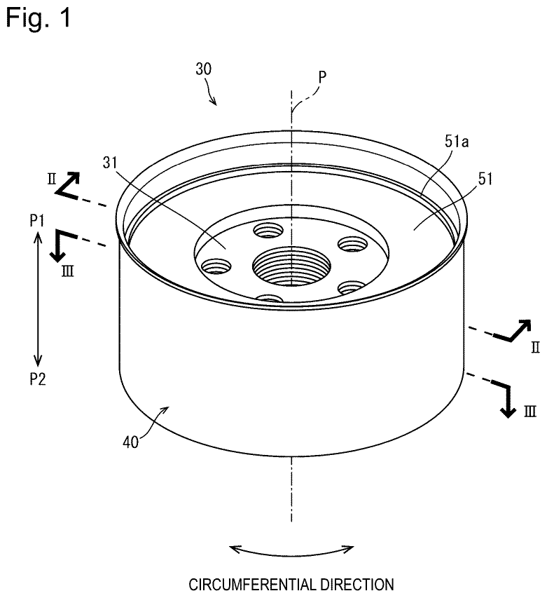

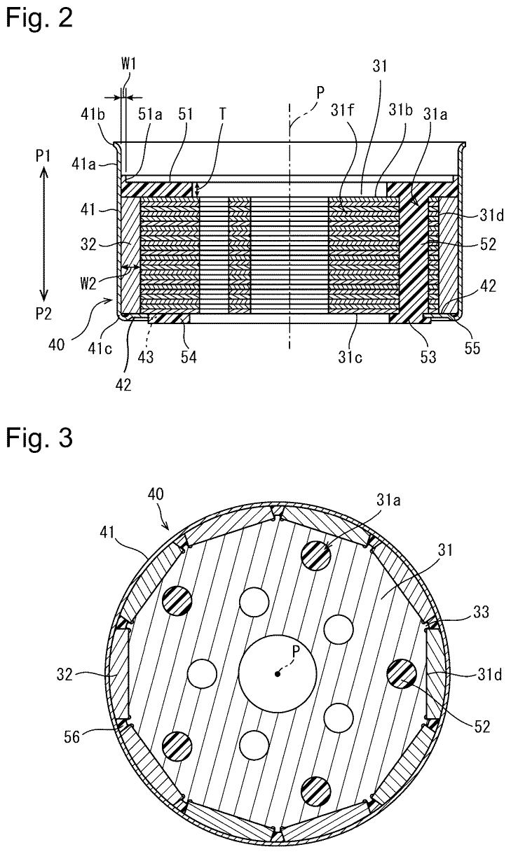

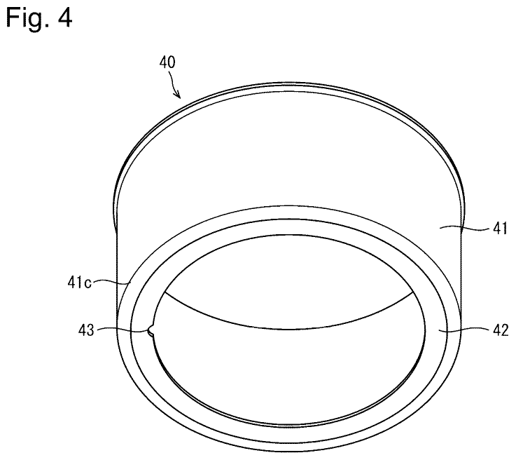

FIG. 1 is a perspective view schematically illustrating a schematic configuration of a rotor 30 according to a first embodiment of the present invention. FIG. 2 is a cross-sectional view taken along line II-II in FIG. 1. FIG. 3 is a cross-sectional view taken along line III-III in FIG. 1. FIG. 4 is a perspective view of the rotor cover illustrated in FIG. 1 as viewed from a bottom side. In FIG. 1 and the like, illustration of a shaft that is a rotational axis of a rotor is omitted for convenience of description.

Referring to FIGS. 1 to 4, the rotor 30 is located radially inward of a cylindrical stator (not illustrated) so as to be rotatable about the central axis P. A motor (not illustrated) having such a structure is called an inner rotor type motor. Since the configurations of the motor and the stator are similar to the conventional configurations, detailed description of the motor and the stator is omitted.

The rotor 30 includes a rotor core 31, a plurality of rotor magnets 32, a rotor cover 40, and a resin portion 51.

The rotor core 31 has a polygonal columnar shape extending along the central axis P. The rotor core 31 includes a plurality of plate-like rotor core members 31f having a polygonal shape when the rotor core 31 is viewed in the axial direction. Each of the plurality of rotor core members 31f is made of an electromagnetic steel sheet, and is stacked in the thickness direction.

When the rotor core 31 is viewed in the axial direction, the rotor core 31 has a protruding ridge 33 extending from the one-side end surface 31b to the other-side end surface 31c in the axial direction of the rotor core 31 at each vertex portion of the polygonal rotor core 31. In addition, the rotor core 31 has an arrangement surface 31d between the protruding ridges 33 adjacent to each other in the circumferential direction when the rotor core 31 is viewed in the axial direction.

The rotor core 31 has a plurality of through holes 31a penetrating the rotor core 31 in the axial direction.

The plurality of rotor magnets 32 are positioned radially outward of each side of the polygonal rotor core 31 when viewed in the axial direction of the rotor core 31. That is, the rotor magnet 32 is positioned on each of the arrangement surfaces 31d of the rotor core 31. The rotor magnet 32 has a planar shape on the radially inner side facing the arrangement surface 31d of the rotor core 31. The rotor magnet 32 has a phase shape in which the radially outer side protrudes radially outward when viewed in the axial direction of the rotor core 31. The axial length of the rotor magnet 32 is equivalent to the axial length of the rotor core 31.

The rotor cover 40 is made of, for example, a nonmagnetic metal such as SUS304. The rotor cover 40 covers the rotor core 31 in which the rotor magnet 32 is disposed. The rotor cover 40 includes a side wall portion 41 and an extending portion 42.

The side wall portion 41 has a cylindrical shape and covers the radially outer side of the rotor core 31 where the rotor magnet 32 is positioned radially outward. In other words, as particularly shown in FIG. 3, the rotor magnet 32 is positioned between the inner peripheral surface of the side wall portion 41 and the radially outer side of the rotor core 31 when viewed in the axial direction of the rotor core 31. That is, the radially outer shape of the rotor magnet 32 has a shape along the inner peripheral surface of the side wall portion 41.

The side wall portion 41 has a protruding portion 41a protruding to one side P1 in the axial direction with respect to the one-side end surface 31b in the axial direction of the rotor core 31 at one axial end. The protruding portion 41a has a one-side tip 41b that extends radially outward toward the one-side tip in the axial direction. As a result, the rigidity of the rotor cover 40 is improved. Therefore, it is possible to suppress vibration generated in the protruding portion 41a of the rotor cover 40 when the rotor 30 rotates.

The extending portion 42 extends radially inward at the other-side end portion 41c in the axial direction of the side wall portion 41. A rib protruding to the other side P2 in the axial direction is located in the entire circumferential direction at a connection portion between the extending portion 42 and the other-side end portion 41c. Further, the extending portion 42 has a notch portion 43 at a radially inner end portion.

The resin portion 51 is made of, for example, polybutylene terephthalate (PBT). The resin portion 51 may be made of a thermosetting resin, or may be made of a thermoplastic resin. The resin portion 51 covers a part of the one-side end surface 31b in the axial direction of the rotor core 31. The resin portion 51 includes a columnar portion 52 positioned in the through hole 31a of the rotor core 31, and a retaining portion 53 extending from the other side in the axial direction of the columnar portion 52 to the other side P2 in the axial direction of the extending portion 42 of the rotor cover 40. The resin portion 51 has a rotation prevention portion 54 extending from the other side in the axial direction of the columnar portion 52 up to the notch portion 43 of the rotor cover 40.

The resin portion 51 has an inter-magnet filling portion 56 in a space surrounded by the radial inside of the rotor cover 40, the rotor magnet 32, and the protruding ridge 33 of the rotor core 31.

Therefore, the rotor core 31, the rotor magnet 32, and the rotor cover 40 are integrated by the resin portion 51.

The resin portion 51 has, on the radially outer side, an edge portion 51a that protrudes to the one side P1 and in the axial direction is in contact with the radially inner side of the protruding portion 41a. The edge portion 51a is located in the entire circumferential direction on the radially inner side of the protruding portion 41a. Therefore, the edge portion 51a is in contact with the radially inner side of the protruding portion 41a in the entire circumferential direction. As a result, it is possible to more stably suppress the vibration generated in the rotor cover 40 when the rotor 30 rotates.

A width W1 in the radial direction of the edge portion 51a is smaller than a thickness T in the axial direction of the resin portion 51. As a result, the amount of resin used to form the edge portion 51a of the resin portion 51 can be reduced. The volume of the edge portion 51a is desirably as small as possible.

Although it has been described that the width W1 in the radial direction of the edge portion 51a is smaller than the width W2 in the radial direction of the rotor magnet 32, the width W1 may be the same as the width W2. As a result, the amount of resin used to form the resin portion 51 can be reduced.

The one-side tip 41b in the axial direction of the protruding portion 41a of the rotor cover 40 is located on the one side P1 in the axial direction with respect to the one-side tip in the axial direction of the edge portion 51a of the resin portion 51 in the axial direction. As a result, the radially outer side of the edge portion 51a is covered with the protruding portion 41a of the rotor cover. Therefore, during the rotation of the rotor, the radially outward movement of the edge portion 51a is restricted by the protruding portion 41a of the rotor cover 40. Therefore, it is possible to prevent the edge portion 51a from extending radially outward due to centrifugal force when the rotor rotates.

As described above, the rotor 30 includes the columnar rotor core 31 extending in the axial direction, the rotor cover 40 covering the radial outside of the rotor core 31, and the resin portion 51 covering the one-side end surface 31b in the axial direction of the rotor core 31. The rotor cover 40 has the protruding portion 41a protruding to the one side P1 in the axial direction with respect to the one-side end surface 31b in the axial direction of the rotor core 31. The resin portion 51 has, on the radially outer side, the edge portion 51a that protrudes to the one side P1 in the axial direction and is in contact with the radially inner side of the protruding portion 41a.

In the above-described configuration, the edge portion 51a of the resin portion 51 is in contact with the radially inner side of the protruding portion 41a of the rotor cover 40. Therefore, during rotation of the rotor 30, the edge portion 51a of the resin portion 51 suppresses deformation of the protruding portion 41a in the radial direction. Therefore, when the rotor 30 rotates, vibration generated in the protruding portion 41a of the rotor cover 40 protruding in the axial direction of the rotor core 31 can be suppressed by the edge portion 51a of the resin portion 51.

The rotor core 31 has the through hole 31a axially penetrating the rotor core 31, and the rotor cover 40 has the extending portion 42 extending radially inward at the other-side end portion 41c in the axial direction. The resin portion 51 includes the columnar portion 52 positioned in the through hole 31a of the rotor core 31, and the retaining portion 53 extending from the other side in the axial direction of the columnar portion 52 up to the other side P2 in the axial direction of the extending portion 42 of the rotor cover 40. As a result, the retaining portion 53 restricts the movement of the rotor cover 40 to the one side P1 in the axial direction. Therefore, the rotor cover 40 can be prevented from coming off from the rotor core 31.

Further, the rotor cover 40 has the notch portion 43 located at the radially inner end portion of the extending portion 42. In addition, the resin portion 51 has the rotation prevention portion 54 extending from the other side in the axial direction of the columnar portion 52 up to the notch portion 43 of the rotor cover 40. As a result, the rotation prevention portion 54 restricts the movement of the rotor cover 40 in the circumferential direction. Therefore, it is possible to prevent the rotor cover 40 from rotating with respect to the rotor core 31.

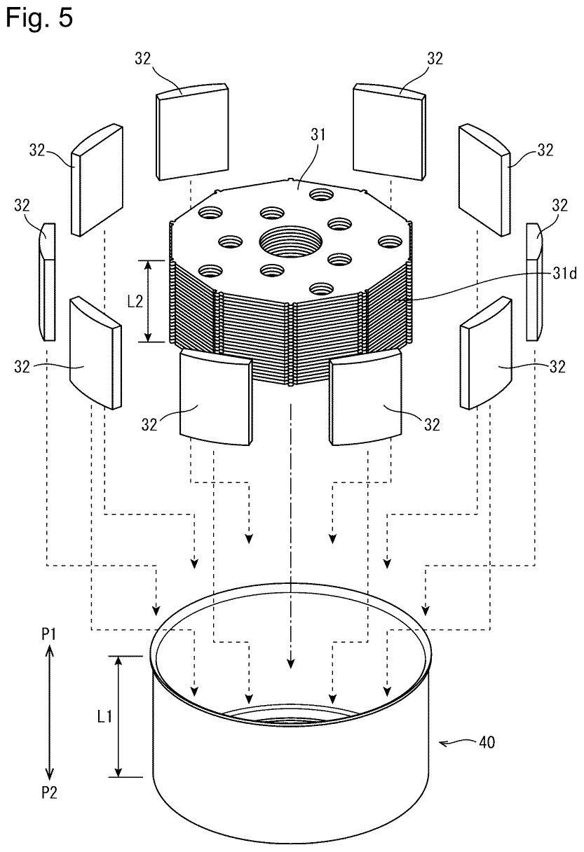

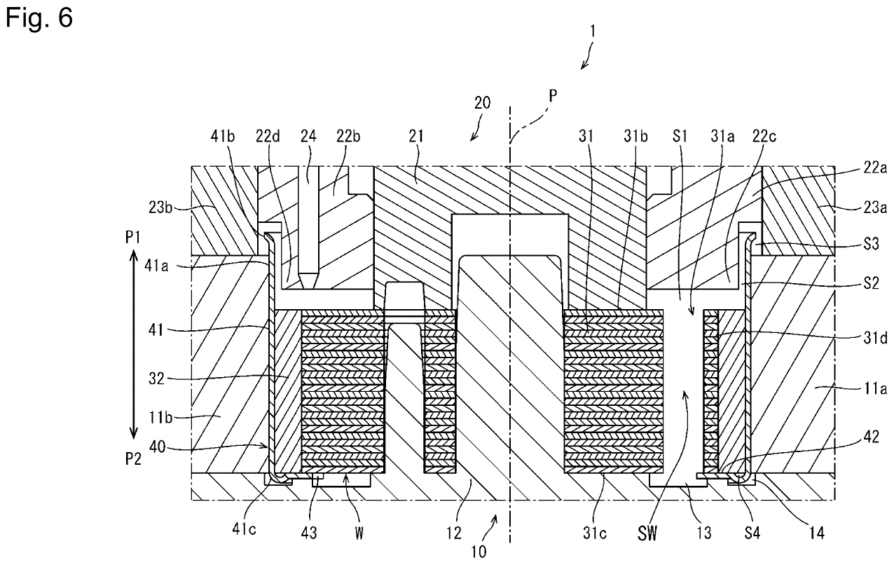

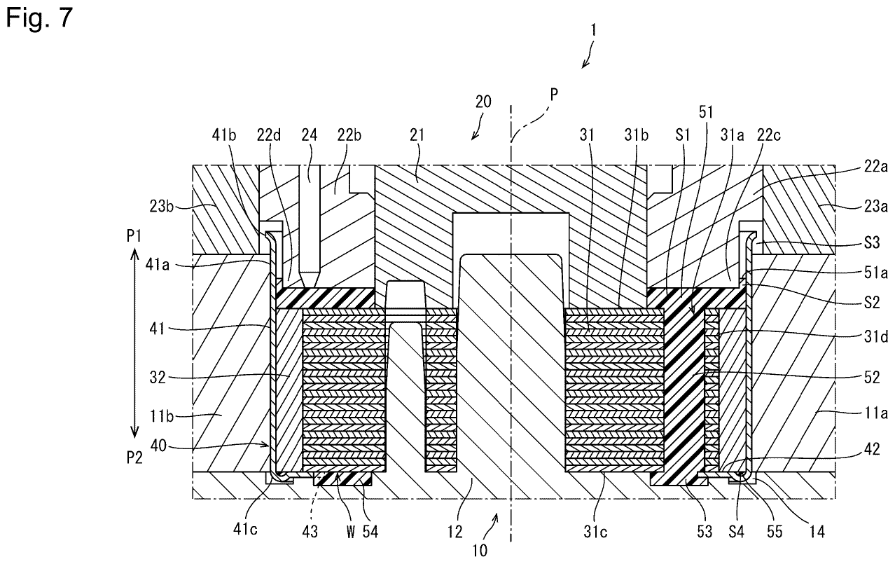

FIG. 5 is a diagram describing one step included in a method of manufacturing the rotor 30 according to the embodiment. FIG. 6 is a schematic view illustrating a state in which a workpiece in which the rotor core 31 and the rotor magnets 32 are inserted into the rotor cover 40 is set in a mold of a rotor manufacturing apparatus. FIG. 7 is a schematic view describing a resin injection step in the rotor manufacturing method.

A method of manufacturing the rotor 30 according to the embodiment will be described with reference to FIGS. 5 to 7. The method for manufacturing the rotor 30 includes a rotor cover attaching step, a mold disposition step, and a resin injection step.

First, in the rotor cover attaching step, the rotor core 31 and the rotor magnet 32 are inserted into the rotor cover 40 with reference to FIGS. 1 to 4 described above in addition to FIG. 5, and the one-side end portion in the axial direction of the side wall portion 41 of the rotor cover 40 is positioned at a position protruding with respect to the one-side end surface 31b in the axial direction of the rotor core 31.

More specifically, it is noted as follows. First, while the rotor magnet 32 is positioned on the arrangement surface 31d of the rotor core 31, the rotor core 31 and the rotor magnet 32 are inserted into the rotor cover 40. At this time, the rotor core 31 and the rotor magnet 32 are moved with respect to the rotor cover 40 from the one side P1 to the other side P2 in the axial direction of the rotor core 31 to a position where the rotor core 31 and the rotor magnet 32 are in contact with one side in the axial direction of the extending portion 42 of the rotor cover 40. Therefore, the rotor core 31 and the rotor magnet 32 can be positioned with respect to the rotor cover 40 by the extending portion 42.

As a result, the radially outer sides of the rotor core 31 and the rotor magnet 32 are covered with the rotor cover 40.

The length L1 in the axial direction of the rotor cover 40 is larger than the length L2 in the axial direction of the rotor core 31. Therefore, the one-side end portion in the axial direction of the side wall portion 41 of the rotor cover 40 protrudes with respect to the one-side end surface 31b in the axial direction of the rotor core 31. That is, the one-side end portion of the side wall portion 41 of the rotor cover 40 corresponds to the above-described protruding portion 41a.

The workpiece W configured of the rotor core 31, the rotor magnets 32, and the rotor cover 40 in this manner is disposed in the rotor manufacturing apparatus 1.

Here, the configuration of the rotor manufacturing apparatus 1 will be described with reference to FIG. 6 in particular. The rotor manufacturing apparatus 1 includes a first mold 10, a second mold 20, and a resin injection portion 24.

The first mold 10 holds the rotor cover 40 covering the radially outer side of the rotor core 31 in a state in which the protruding portion 41a protrudes to the one side P1 in the axial direction with respect to the one-side end surface 31b in the axial direction of the rotor core 31.

More specifically, the first mold 10 includes a base mold 12 and side molds 11a and 11b. A space SW in which the workpiece W is accommodated is formed by the base mold 12 and the side molds 11a and 11b. The side molds 11a and 11b may be integrated or may be separate.

The base mold 12 has a placement surface on which the workpiece W can be placed. More specifically, the base mold 12 includes a first recess 13 and a second recess 14. The first recess 13 is located at the other side P2 in the axial direction of the through hole 31a of the rotor core 31 with respect to the workpiece W placed on the placement surface. The second recess 14 has a shape capable of accommodating the rib of the extending portion 42 of the rotor cover 40 of the workpiece W placed on the placement surface.

The side molds 11a and 11b constitute side walls of the space SW that accommodates the workpiece W. That is, the side molds 11a and 11b cover the radially outer side of the rotor cover 40 in a state where the workpiece W is placed on the placement surface of the base mold 12.

The second mold 20 is located on one side in the axial direction of the first mold 10 so as to be relatively movable in the axial direction with respect to the first mold 10, and forms a space S1 with the one-side end surface 31b in the axial direction of the rotor core 31. More specifically, the second mold 20 includes a central mold 21, inner molds 22a and 22b, and outer molds 23a and 23b.

The central mold 21 presses the workpiece W placed on the placement surface of the base mold 12 around the central axis P of the one-side end surface 31b in the axial direction of the rotor core 31.

The inner molds 22a and 22b are positioned radially outward of the central mold 21, and form the space S1 with the one-side end surface 31b in the axial direction of the rotor core 31. In addition, the inner molds 22a and 22b have gap forming portions 22c and 22d that form a radial gap S2 with the protruding portion 41a radially inward with respect to the protruding portion 41a of the rotor cover 40 in a state where the workpiece W is sandwiched between the inner molds 22a and 22b and the first mold 10.

The outer molds 23a and 23b are located radially outward of the inner molds 22a and 22b, and are located radially outward of the one-side tip 41b in the axial direction of the protruding portion 41a in a state where the workpiece W is sandwiched between the first mold 10 and the second mold 20. The outer molds 23a and 23b correspond to outer wall portions.

The inner molds 22a and 22b and the outer molds 23a and 23b described above form a space S3 for accommodating the one-side tip 41b in the axial direction of the protruding portion 41a.

In a state where the workpiece W is sandwiched between the first mold 10 and the second mold 20, a radial interval between the gap forming portions 22c and 22d and the rotor cover 40 is smaller than an axial interval between the gap forming portions 22c and 22d and the rotor core 31. That is, in a state where the workpiece W is sandwiched between the first mold 10 and the second mold 20, the radial interval of the gap S2 is smaller than the axial interval of the space S1. As a result, it is possible to reduce the amount of resin used when the resin portion is molded on the one-side end surface 31b of the rotor core 31 in the axial direction. The radial interval of the gap S2 is desirably as small as possible.

The resin injection portion 24 is provided in the inner mold 22b of the second mold 20, and resin is injected into the space formed by the first mold 10, the second mold 20, and the workpiece W.

With reference to FIG. 6, in particular, in the mold disposition step, by sandwiching the workpiece W between the first mold 10 and the second mold 20 of the rotor manufacturing apparatus 1 described above, the space S1 is formed between the second mold 20 and the one-side end surface 31b in the axial direction of the rotor core 31, and the gap S2 is formed radially inward of the one-side end portion of the side wall portion 41 of the rotor cover 40 and between the second mold 20 and the one-side end portion of the side wall portion 41 of the rotor cover 40. In other words, the gap S2 is formed between the second mold 20 and the protruding portion 41a of the rotor cover 40. In the mold disposition step, the first recess 13 of the first mold 10 is positioned at the other side P2 in the axial direction of the through hole 31a of the rotor core 31. The first recess 13 corresponds to a recess.

In the resin injection step, with reference to FIG. 7 in particular, resin is injected from the resin injection portion 24 into the first mold 10 and the second mold 20 to mold the workpiece W. More specifically, in the resin injection step, the resin is injected into each of the space S1, the gap S2, the through hole 31a of the rotor core 31, and the first recess 13.

In the resin injection step, the resin portion 51 is formed by injecting resin into the space S1. In addition, the edge portion 51a is formed by injecting resin into a part of the gap S2.

In order to adjust the height of the edge portion 51a formed in the gap S2, it is preferable to adjust the amount of resin to be injected and the molding conditions in the resin injection step. That is, it is preferable to adjust the amount of resin to be injected and the molding conditions such that the one-side tip 41b in the axial direction of the protruding portion 41a of the rotor cover 40 is located on the one side P1 in the axial direction with respect to the one-side tip in the axial direction of the edge portion 51a of the resin portion 51 in the axial direction.

In addition, the columnar portion 52 is formed by injecting resin into the through hole 31a of the rotor core 31. Further, in the resin injection step, resin is injected into the first recess 13 of the first mold 10 through the through hole 31a of the rotor core 31, so that the rotation prevention portion 54 that restricts the movement of the extending portion 42 of the rotor cover 40 in the circumferential direction of the rotor cover 40 and the retaining portion 53 that restricts the movement of the extending portion 42 in to the one side P1 in the axial direction are formed on the other-side end surface 31c in the axial direction of the rotor core 31. The rotation prevention portion 54 and the retaining portion 53 function as restricting portions that restrict the movement of the rotor cover 40.

With reference also to FIG. 3, in the resin injection step, resin passes through the space on the side of the rotor core 31 from the one-side end surface 31b in the axial direction of the rotor core 31, and flows into the back side of the rib of the extending portion 42 of the rotor cover 40. That is, in the resin injection step, the resin passes from the space S1 through a space surrounded by the radially inner side of the rotor cover 40, the rotor magnet 32, and the protruding ridge 33 of the rotor core 31, and is poured into the space S4 formed on the one side P1 in the axial direction of the rib of the extending portion 42 of the rotor cover 40. In the resin injection step, the resin flows into these spaces to form the inter-magnet filling portion 56 and a rib rear resin portion 55.

As described above, the rotor manufacturing apparatus 1 is a manufacturing apparatus for manufacturing the rotor 30 in which the radially outer side of the columnar rotor core 31 extending in the axial direction is covered with the rotor cover 40 and the one-side end surface 31b of the rotor core 31 in the axial direction is covered with the resin portion 51. The rotor manufacturing apparatus 1 includes: the first mold 10 that holds the rotor cover 40 that covers the radially outer side of the rotor core 31 in a state where the protruding portion 41a protrudes to the one side P1 in an axial direction with respect to the one-side end surface 31b in the axial direction of the rotor core 31; the second mold 20 that is located on the one side P1 in the axial direction of the first mold 10 so as to be relatively movable in the axial direction with respect to the first mold 10 and forms the space S1 with the one-side end surface 31b in the axial direction of the rotor core 31; and the resin injection portion 24 from which resin is injected into the space S1.

The second mold 20 includes the gap forming portions 22c and 22d that form the gap S2 in the radial direction with the protruding portion 41a radially inward of the protruding portion 41a of the rotor cover 40 in a state where the rotor core 31 and the rotor cover 40 are sandwiched between the second mold 20 and the first mold 10.

According to the rotor manufacturing apparatus 1, it is possible to realize a manufacturing apparatus capable of forming the resin portion 51 on one side in the axial direction of the rotor core 31. By using the rotor manufacturing apparatus 1, the edge portion 51a that is in contact with the protruding portion 41a of the rotor cover 40 and protrudes to one side in the axial direction is formed on the radially outer side of the resin portion 51.

In addition, in the rotor manufacturing apparatus 1, the first mold 10 or the second mold 20 further includes the outer molds 23a and 23b located radially outward of the one-side tip 41b in the axial direction of the protruding portion 41a in a state where the rotor core 31 and the rotor cover 40 are sandwiched between the first mold 10 and the second mold 20. Accordingly, at the time of resin injection, it is possible to prevent the second mold 20 from coming into contact with the one-side tip 41b of the protruding portion 41a of the rotor cover 40. Therefore, deformation of the protruding portion 41a of the rotor cover 40 at the time of resin injection can be suppressed.

Further, as described above, the rotor manufacturing method is a manufacturing method of manufacturing the rotor 30 in which the radially outer side of the columnar rotor core 31 extending in the axial direction is covered with the rotor cover 40 and the one-side end surface 31b of the rotor core 31 in the axial direction is covered with the resin portion 51. Here, the axial length of the rotor cover 40 is larger than the axial length of the rotor core 31. As described above, the rotor manufacturing method includes the rotor cover attaching step, the mold disposition step, and the resin injection step.

In the rotor cover attaching step, the rotor core 31 is inserted into the rotor cover 40, and the one-side end portion in the axial direction of the rotor cover 40 is positioned at a position protruding with respect to the one-side end surface 31b in the axial direction of the rotor core 31.

In the mold disposition step, the rotor core 31 and the rotor cover 40 are sandwiched between the first mold 10 and the second mold 20, so that the space S1 is formed between the second mold 20 and the one-side end surface 31b of the rotor core 31 in the axial direction, and the gap S2 is formed radially inward of the one-side end portion of the rotor cover 40 and between the second mold 20 and the one-side end portion of the rotor cover 40.

In the resin injection step, resin is injected into the space S1 and the gap S2. As a result, the rotor core 31, the rotor magnet 32, and the rotor cover 40 are molded and integrated by the resin.

According to the rotor manufacturing method, it is possible to obtain the rotor 30 in which the vibration generated in the protruding portion 41a of the rotor cover 40 during rotation of the rotor 30 can be suppressed by the edge portion 51a of the resin portion 51. Moreover, in the process of manufacturing the rotor 30, it is not necessary to prepare a work-in-process in which the rotor core 31 and the rotor magnet 32 are assembled, so that the production efficiency of the rotor 30 is improved.

In addition, in the rotor manufacturing method, the rotor core 31 has the through hole 31a axially penetrating the rotor core 31, the rotor cover 40 has the extending portion 42 extending radially inward at the other-side end portion 41c in the axial direction, and the first mold 10 has the first recess 13.

In the mold disposition step, when the rotor core 31 and the rotor cover 40 are sandwiched between the first mold 10 and the second mold 20, the first recess 13 of the first mold 10 is positioned at the other side P2 in the axial direction of the through hole 31a of the rotor core 31.

In the resin injection step, resin is further injected into the first recess 13 of the first mold 10 through the through hole 31a of the rotor core 31 to form a restricting portion that restricts at least one of the movement of the extending portion 42 of the rotor cover 40 in the circumferential direction of the rotor cover 40 and the movement of the extending portion 42 in the axial direction, on the other-side end surface 31c in the axial direction of the rotor core 31.

Thus, the movement of the rotor cover 40 can be restricted by the resin flowing into the first recess 13. Therefore, a structure for preventing the rotor cover 40 from coming off or being removed from the rotor core 31 is obtained.

While the embodiment of the present invention has been described above, the above embodiment is merely an example for implementing the present invention. Thus, the present invention is not limited to the embodiment described above, and the embodiment described above may be appropriately modified and implemented without departing from the scope of the present invention.

In the above embodiment, it has been described that the rotor core 31 has a polygonal columnar shape, but the present invention is not limited thereto, and the rotor core 31 may have another shape. For example, the rotor core may have a cylindrical shape.

In the above embodiment, the rotor cover 40 is made of a nonmagnetic metal such as SUS304. However, the rotor cover may be made of another non-magnetic material. For example, the rotor cover may be made of resin. In addition, the material of the rotor cover may be a material other than a non-magnetic material.

In the above embodiment, the rotor cover 40 has the extending portion 42 extending radially inward at the other-side end portion 41c in the axial direction of the side wall portion 41, but the present invention is not limited thereto. The extending portion may be omitted in the rotor cover.

In the above embodiment, it has been described that the edge portion 51a is located in the entire circumferential direction on the radially inner side of the protruding portion 41a. However, the present invention is not limited thereto, and the edge portion may be located at a part of the protruding portion in the circumferential direction on the radially inner side.

In the above embodiment, it has been described that the one-side tip 41b in the axial direction of the protruding portion 41a of the rotor cover 40 is located on the one side P1 in the axial direction with respect to the one-side tip in the axial direction of the edge portion 51a of the resin portion 51 in the axial direction. However, the present invention is not limited thereto, and the one-side tip in the axial direction of the protruding portion of the rotor cover may be at the same position as the one-side tip in the axial direction of the edge portion of the resin portion in the axial direction. Note that the one-side tip in the axial direction of the protruding portion of the rotor cover may be located on the other side in the axial direction with respect to the one-side tip in the axial direction of the edge portion of the resin portion in the axial direction.

In the embodiment described above, the width W1 of the edge portion 51a in the radial direction is smaller than the thickness T of the resin portion 51 in the axial direction. However, the present invention is not limited thereto, and the radial width of the edge portion may be the same as the axial thickness of the resin portion. Alternatively, the radial width of the edge portion may be larger than the axial thickness of the resin portion.

In the above embodiment, it has been described that the rotor 30 includes the rotor magnet 32 located on the radially outer side of the rotor core 31, and the width W1 in the radial direction of the edge portion 51a is smaller than the width W2 in the radial direction of the rotor magnet 32. However, the present invention is not limited thereto, and the radial width of the edge portion may be the same as the radial width of the rotor magnet. Moreover, the present invention is not limited thereto, and the radial width of the edge portion may be larger than the radial width of the rotor magnet.

Although not specifically described in the above embodiment, the width W1 in the radial direction of the edge portion 51a may or may not be uniform in the circumferential direction. For example, the edge portion may have a reinforcement portion that is wider than the other portion on the radially inner side of a part in the circumferential direction. As a result, it is possible to suppress the edge portion from expanding radially outward due to the centrifugal force when the rotor rotates.

In the above embodiment, it has been described that the first mold 10 and the second mold 20 have specific structures. That is, the first mold 10 includes the base mold 12 and the side molds 11a and 11b. More specifically, the second mold 20 includes the central mold 21, the inner molds 22a and 22b, and the outer molds 23a and 23b. However, the present invention is not limited thereto, and each of the first mold and the second mold may be configured as a single member or may further include another member.

In the above embodiment, the inner mold 22b of the second mold 20 has the resin injection portion 24, but the present invention is not limited thereto. Any member of the second mold and the first mold may have the resin injection portion.

In the above embodiment, it has been described that the radial interval of the gap S2 is smaller than the axial interval of the space S1 formed between the second mold 20 and the one-side end surface 31b of the rotor core 31 in the axial direction. However, the present invention is not limited thereto, and in a state where the workpiece is sandwiched between the first mold and the second mold, the radial interval of the gap may be equal to the axial interval of the space. The radial interval of the gap may be larger than the axial interval of the space.

In the embodiment described above, in the rotor cover attaching step, the rotor core 31 and the rotor magnet 32 are inserted into the rotor cover 40 while the rotor magnet 32 is positioned with respect to the rotor core 31. The present invention is not limited thereto, and a work-in-process in which a rotor magnet is previously fixed to a rotor core with an adhesive or the like may be inserted into the rotor cover.

In the above embodiment, it has been described that the rotation prevention portion 54 and the retaining portion 53 are formed as the restricting portions by the resin injection process, but the formation of the restricting portions may be omitted. Further, the formation of the inter-magnet filling portion and the rib rear resin portion may be omitted.

The present invention is applicable to a rotor and a motor in which the rotor is incorporated.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor comprising:
a rotor core having a columnar shape and extending in an axial direction;
a rotor cover that covers an outer side in a radial direction of the rotor core; and
a resin portion that covers a one-side end surface in the axial direction of the rotor core,
wherein the rotor cover includes a protruding portion protruding to one side in the axial direction with respect to the one-side end surface in the axial direction of the rotor core, and
the resin portion includes, on an outer side in the radial direction, an edge portion that protrudes to one side in the axial direction and is in contact with an inner side in the radial direction of the protruding portion.

2. The rotor according to claim 1, wherein a one-side tip in the axial direction of the protruding portion of the rotor cover is located at a same position as a one-side tip in the axial direction of the edge portion of the resin portion, or located on one side in the axial direction with respect to the one-side tip in the axial direction of the edge portion of the resin portion.

3. The rotor according to claim 1, wherein a width of the edge portion in the radial direction is equal to or smaller than a thickness of the resin portion in the axial direction.

4. The rotor according to claim 1, further comprising a rotor magnet located on an outer side in the radial direction of the rotor core,
wherein a width of the edge portion in the radial direction is equal to or smaller than a width of the rotor magnet in the radial direction.

5. The rotor according to claim 1, wherein the edge portion is located on an inner side in the radial direction of the protruding portion in an entire circumferential direction.

6. The rotor according to claim 1, wherein the edge portion includes a reinforcement portion on an inner side in the radial direction.

7. The rotor according to claim 2, wherein the protruding portion includes a tip portion extending outward in the radial direction toward the one-side tip in the axial direction.

8. The rotor according to claim 1, wherein
the rotor core includes a through hole penetrating the rotor core in the axial direction,
the rotor cover includes an extending portion extending inward in the radial direction at an another-side end portion in the axial direction, and
the resin portion includes
a columnar portion located in the through hole of the rotor core; and
a retaining portion extending from another side in the axial direction of the columnar portion to another side in the axial direction of the extending portion of the rotor cover.

9. The rotor according to claim 1, wherein
the rotor core includes a through hole penetrating the rotor core in the axial direction,
the rotor cover includes
an extending portion extending inward in the radial direction at another-side end portion in the axial direction, and
a notch portion located at an inner end portion of the extending portion in the radial direction, and
the resin portion includes
a columnar portion located in the through hole of the rotor core, and
a rotation prevention portion extending from another side in the axial direction of the columnar portion to inside of the notch portion of the rotor cover.

10. A rotor manufacturing apparatus for manufacturing a rotor in which an outer side in a radial direction of a rotor core having a columnar shape and extending in an axial direction is covered with a rotor cover, and a one-side end surface in the axial direction of the rotor core is covered with a resin portion, the rotor manufacturing apparatus comprising:
a first mold that holds the rotor cover covering the outer side in the radial direction of the rotor core in a state where a protruding portion protrudes to one side in the axial direction with respect to one-side end surface in the axial direction of the rotor core;
a second mold that is located on one side in the axial direction of the first mold so as to be relatively movable in the axial direction with respect to the first mold, and forms a space between the second mold and the one-side end surface in the axial direction of the rotor core; and
a resin injection portion from which resin is injected into the space,
wherein the second mold includes a gap forming portion in which a gap is formed in the radial direction between the second mold and the protruding portion on an inward side in the radial direction with respect to the protruding portion of the rotor cover, in a state where the rotor core and the rotor cover are sandwiched between the second mold and the first mold.

11. The rotor manufacturing apparatus according to claim 10, wherein in a state where the rotor core and the rotor cover are sandwiched between the first mold and the second mold, an interval between the gap forming portion and the rotor cover in the radial direction is equal to or smaller than an interval between the gap forming portion and the rotor core in the axial direction.

12. The rotor manufacturing apparatus according to claim 10, wherein the first mold or the second mold further includes an outer wall portion located outward in the radial direction of a one-side tip in the axial direction of the protruding portion, in the state where the rotor core and the rotor cover are sandwiched between the first mold and the second mold.

13. A rotor manufacturing method for manufacturing a rotor in which an outer side in a radial direction of a rotor core having a columnar shape and extending in an axial direction is covered with a rotor cover, and a one-side end surface in the axial direction of the rotor core is covered with a resin portion, the rotor manufacturing method comprising:
a rotor cover attaching step of inserting the rotor core into the rotor cover, a length of the rotor cover in the axial direction is larger than a length of the rotor core in the axial direction, and positioning a one-side end portion in the axial direction of the rotor cover at a position protruding to the one-side end surface in the axial direction of the rotor core;
a mold disposition step of sandwiching the rotor core and the rotor cover between a first mold and a second mold to form a space between the second mold and the one-side end surface of the rotor core in the axial direction, and form a gap between the second mold and the one-side end portion of the rotor cover on an inward side of the one-side end portion of the rotor cover; and
a resin injection step of injecting resin into the space and the gap.

14. The rotor manufacturing method according to claim 13, wherein
the rotor core includes a through hole penetrating the rotor core in the axial direction,
the rotor cover includes an extending portion extending inward in the radial direction at another-side end portion in the axial direction,
the first mold includes a recess,
the mold disposition step includes, when sandwiching the rotor core and the rotor cover between the first mold and the second mold, positioning the recess of the first mold on another side in the axial direction of the through hole of the rotor core, and
the resin injection step further includes injecting resin into the recess of the first mold via the through hole of the rotor core to form a restricting portion on an another-side end surface in the axial direction of the rotor core, the restricting portion restricting at least one of movement of the extending portion of the rotor cover in the circumferential direction and movement of the extending portion in the axial direction.
